(19) United States
(12) Patent Application Publication
(10) Pub. No.: US 2024/0220949 A1
(43) Pub. Date: Jul. 4, 2024

(54) SYSTEMS, METHODS, AND APPARATUSES FOR IMPLEMENTING AN INTERCONNECTED DISTRIBUTED NETWORK OF RESOURCE DISTRIBUTION DEVICES

(71) Applicant: BANK OF AMERICA CORPORATION, Charlotte, NC (US)

(72) Inventors: Joseph Benjamin Castinado, North Glenn, CO (US); Paul Martin Mattison, Sherrills Ford, NC (US)

(73) Assignee: BANK OF AMERICA CORPORATION, Charlotte, NC (US)

(21) Appl. No.: 18/092,862

(22) Filed: Jan. 3, 2023

(51) Int. Cl. G06Q 20/10; G06F 9/50

(52) U.S. Cl. CPC G06Q 20/102; G06F 9/5005

(57) ABSTRACT

Systems, computer program products, and methods are described herein for implementing an interconnected distributed network of resource distribution devices. The present disclosure is configured to receive a resource processing event request at a resource distribution device, wherein the resource processing event request is associated with a user. The system may also determine that the user is authenticated to request the resource processing event. Further, in response to determining that the user is authenticated to request the resource processing event, the system may initiate execution of the resource processing event.

### TECHNOLOGICAL FIELD

Example embodiments of the present disclosure relate to implementing an interconnected distributed network of resource distributions devices.

### BACKGROUND

Implementing conventional resource distribution devices can be a time consuming and resource intensive process, particularly when implementing conventional stand-alone, limited function resource distribution devices. Conventional resource distribution devices require sophisticated installation procedures, maintenance and upkeep, and pose security concerns for users interacting with the resource distribution devices. However, implementing an interconnected distribution network of resource distribution devices may comprise using existing resource distribution devices of all types to reduce the issues that result from conventional resource distribution devices.

There are a number of deficiencies and problems associated with implementing an interconnected distributed network of resource distribution devices (e.g., limitations to one resource distribution network of a single entity, inability to recycle resources, and the like). Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

Systems, methods, and computer program products are provided for implementing an interconnected distributed network of resource distribution devices. For sample, illustrative purposes, system environments will be summarized.

In one aspect, a system for implementing an interconnected distributed network of resource distribution devices is provided. The system may receive a resource processing event request at a resource distribution device. The resource processing event request is associated with a user. The may also determine that the user is authenticated to request the resource processing event. in response to determining that the user is authenticated to request the resource processing event, the system can initiate execution of the resource processing event.

In some embodiments, the resource processing event includes a deposit of physical resources made by the user into the resource distribution device. In some embodiments, the system transmits an indication that the resource distribution device is ready to receive the deposit of physical resources via a deposit receptacle. In some embodiments, the system receives, via the deposit receptacle, the deposit of physical resources.

In some embodiments, the system verifies the deposit of physical resources. In some embodiments, verifying the deposit of physical resources includes analyzing individual resources of the deposit of physical resources to determine whether the individual resources of the deposit of physical resources are authentic. In response to determining that the individual resources are authentic, the system transmits an amount of virtual credits to a user account associated with the user, wherein the amount of virtual credits is associated with a value of the deposited resources. Alternatively, in response to determining that the individual resources are not authentic, the system transmits an alert to a display of the resource distribution device.

In some embodiments, the resource processing event includes a dispense of physical resources from the resource distribution device. In some embodiments, the physical resources include a value associated with an amount of virtual credits in an account for the user. In some embodiments, system may dispense the physical resources via a deposit receptacle, and debit the amount of virtual credits from the account of the user.

In some embodiments, the step of determining that the user is authenticated further comprises transmitting a request for authentication credentials associated with the user account to a user device in response to receiving the resource processing event request. The system may then receive authentication credentials from the user device. The system can then determine that the received authentication credentials match known authentication credentials associated with the user. In response to determining that the received authentication credentials match the known authentication credentials, the system can then initiate the execution of the resource processing event.

In some embodiments, in response to determining that the received authentication credentials match the known authentication credentials, the system may transmit a confirmation of the authentication to the user device.

In some embodiments, the user account is associated with an entity different than an entity that manages the resource distribution device.

Receiving the resource processing event request may, in some embodiments, include receiving a request to execute the resource processing event at a future point in time. In such embodiments, the step of initiating the execution of the resource processing event may include transmitting a unique coded event signal to a mobile computing device associated with the user. Subsequently, the system may receive, at the resource distribution device, a near-field communication coded signal. The system may then determine that the received near-field communication coded signal matches the unique transmitted coded event signal. In response to such a determination, the system can then dispense certain physical resources associated with the resource processing event via a dispensing receptacle of the resource distribution device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures:

FIGS. 1A-1C illustrate technical components of an exemplary distributed computing environment for implementing an interconnected distributed network of resource distribution devices, in accordance with example embodiments of the present disclosure;

FIG. 2 illustrates a process flow for implementing an interconnected distributed network of resource distribution devices, in accordance with example embodiments of the present disclosure;

FIG. 3 illustrates a process flow for implementing an interconnected distributed network of resource distribution devices, including debiting an amount of virtual resources from an account of a user, in accordance with example embodiments of the present disclosure;

FIG. 4 illustrates a process flow for implementing an interconnected distributed network of resource distribution devices, including initiating an execution of the resource processing event, in accordance with example embodiments of the present disclosure; and

FIG. 5 illustrates a process flow for implementing an interconnected distributed network of resource distribution devices, including dispensing physical resources associated with the resource processing event via a dispensing receptacle of the resource distribution device, in accordance with example embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents (e.g., physical tokens, tablets, coins, chips, and the like that are associated with a known monetary value), commodities, or the like. For purposes of this disclosure, a resource is typically able to be stored in a resource repository—a storage location (e.g., a resource distribution device) where one or more resources are organized, stored, authenticated, secured, and retrieved through electronic interaction with a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, Internet transactions, online shopping, electronic funds transfers between accounts, transactions with a financial institution teller, personal checks, conducting purchases using loyalty/rewards points, and the like. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

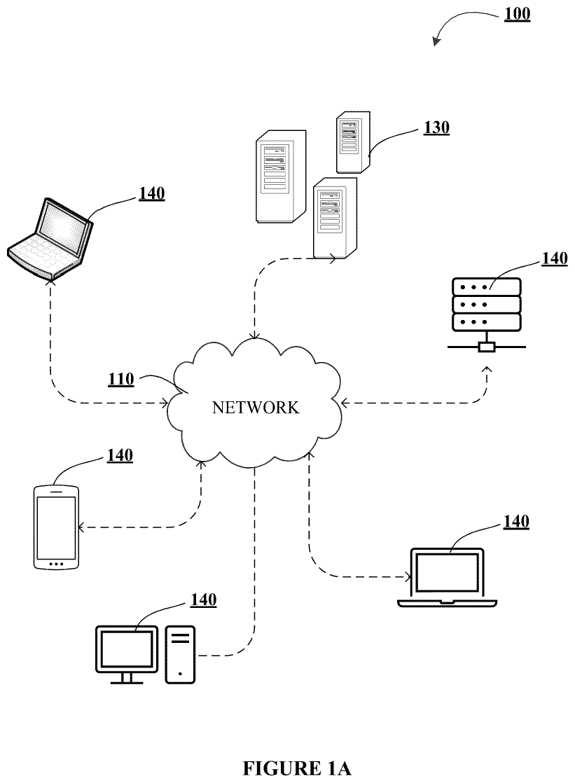

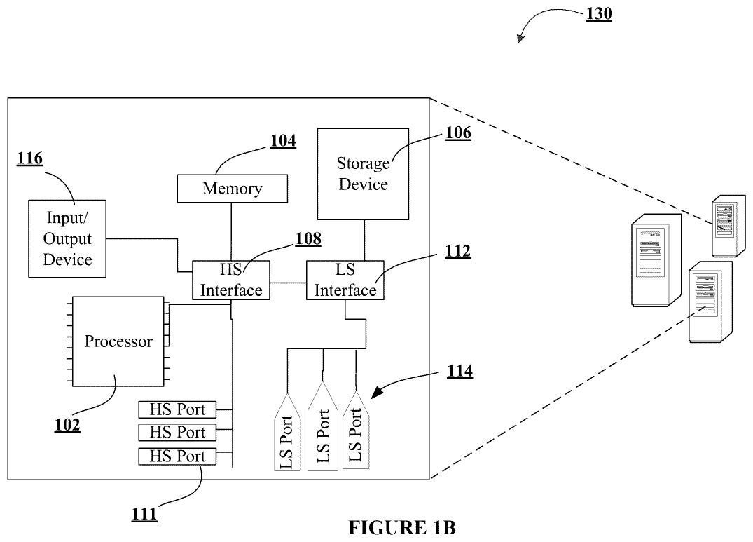

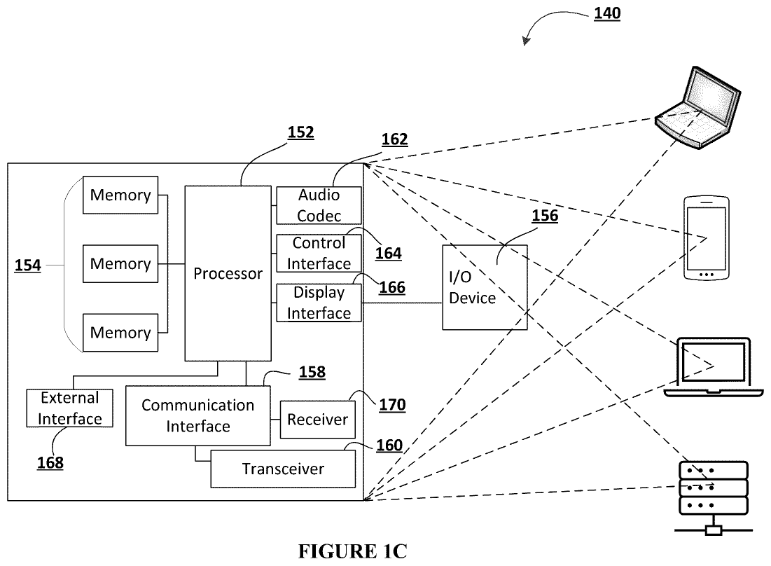

As described in further detail herein, the present disclosure provides a solution to the above-referenced problems in the field of technology by generating a secure, accurate, and efficient process for implementing an interconnected distributed network of resource distribution devices. The present disclosure solves this technical problem by implementing an interconnected distributed network of resource distribution devices over an existing network of resource distribution devices, like that shown as an interconnected resource distribution system 130 in FIGS. 1A-1C. For instance, the interconnected resource distribution system acts to utilize existing resource distribution devices—in real time—by processing resource distribution requests over an existing network of resource distribution devices. Further, the interconnected resource distribution system dynamically responds to resource processing requests from users interacting with resource distribution devices. In addition, the interconnected resource distribution system requests authentication of the user. The interconnected resource distribution system will initiate execution of the resource processing request in response to authenticating the user. Thus, the interconnected resource distribution system provides a technical solution to the technical problem in securely, accurately, and efficiently implementing an interconnected distributed network of resource distribution devices.

Users associated with resource distribution entities (e.g., financial institutions and/or the like) face difficulties in securely requesting resource processing requests at conventional resource distribution devices. Implementing a secure network of physical resource distribution devices that are linked across a distributed electronic network that manages resource processing events is difficult and resource-intensive regarding security features, maintenance and upkeep, and installation of the conventional resource distribution devices. In addition, managing the physical resources stored in the conventional resource distribution devices is a complicated and cumbersome process. Challenges arise surrounding the secure handling of the physical resources among conventional resource distribution devices and around authentication of the user requesting the resource distribution. Without a system that interconnects a distributed network of resource distribution devices, a user's account may become compromised. A need, therefore, exists for implementing an interconnected distributed network of resource distribution devices.

Users of financial institutions or other related entities may wish to access user accounts that are associated with certain resource holdings. For instance, a user may be in a specific physical location that does not offer readily-available access to resource distribution devices associated with the user's specific resource holding that the user wishes to access (e.g., a financial institution's office, and/or ATMs). As such, alternative options are needed to enable other types of devices to enable the user to access their accounts, and process physical resources associated with such accounts.

The inventions described herein provide a system which allows a network of devices (such as merchant devices, point of sale devices, and/or the like which are associated with a specific financial institution and/or a plurality of financial institutions through a peer-to-peer resource sharing electronic network) to be used as point of resource distribution devices. The invention allows the consumer/user to receive an electronic resource transfer through a peer-to-peer resource sharing electronic network, use their electronic device linked to the peer-to-peer resource sharing electronic network with a point of sale device associated with the same peer-to-peer resource sharing electronic network (e.g., a point of sale device/merchant device linked to a financial institution that is associated with the peer-to-peer resource sharing electronic network), and request a physical distribution of the resource received from the peer-to-peer resource sharing electronic network. In some embodiments, the user/consumer may only need to place their electronic device near the point of sale/merchant device for the point of sale/merchant device to recognize the user account and distribute the resources, such embodiments may use near field communication to complete this process. In some embodiments, the invention may be used for a plurality of resource accounts associated with the user account and a financial institution, rather than just the peer-to-peer resource sharing electronic network.

In some embodiments, such a system may be used for resource recycling within physical locations (e.g., a cash recycling system or a physical token recycling system), where instead of financial institutions having to borrow cash to distribute to users and consumers, the users and consumers can use deposited cash at merchant locations for their resource distributions and then later deposited to (or retrieved by) the same user or a different user. In some embodiments, and upon completing a resource transaction using physical resources (such as cash), the invention may request for the user to designate a resource account to transmit the unused resource to (e.g., a checking account, savings account, and/or the like) at the point of sale device.

Embodiments of the present disclosure provide for implementing an interconnected distributed network of resource distribution devices. In this regard, and by way of non-limiting example, the interconnected resource distribution system may receive a resource processing event request (e.g., withdrawal of physical resources, deposit of physical resources, transfer of funds, and/or the like). The interconnected resource distribution system may request authentication of the user (e.g., request the user to input authentication credentials). In response to determining that the user is authenticated, the system initiates execution of the resource processing event. When the resource processing event is a deposit of physical resources (e.g., depositing funds), the interconnected resource distribution system may transmit an indication that the resource distribution device is ready to receive the deposit of physical resources via a deposit receptacle. The interconnected resource distribution system may then receive the deposit of physical resources (e.g., cash) in the deposit receptacle. The interconnected resource distribution system may analyze the individual resources of the deposit to determine whether the individual resources are authentic. In response to determining that the individual resources are authentic, the interconnected resource distribution system may transmit an amount of virtual credits to a user account. In response to determining that the individual resources are not authentic, the interconnected resource distribution system may transmit an alert.

Accordingly, the present disclosure for implementing an interconnected distributed network of resource distribution devices works by receiving a resource processing event request at a resource distribution device, determining that the user is authenticated to request the resource processing event, and, in response to determining that the user is authenticated to request the resource processing event, initiating execution of the resource processing request.

What is more, the present disclosure provides a technical solution to a technical problem. As described herein, the technical problem includes the secure, efficient, and resource-intensive implementation of a network of conventional resource distribution devices. The technical solution presented herein allows for dynamically, securely, and efficiently implementing an interconnected distributed network of resource distribution devices. In particular, implementing an interconnected distributed network of resource distribution devices is an improvement over existing solutions to the secure and efficient network of resource distribution devices, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

FIGS. 1A-1C illustrate technical components of an exemplary distributed computing environment 100 for implementing an interconnected distributed network of resource distribution devices, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed expansion port 114 and storage device 106. Each of the components 102, 104, 106, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, and the like) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

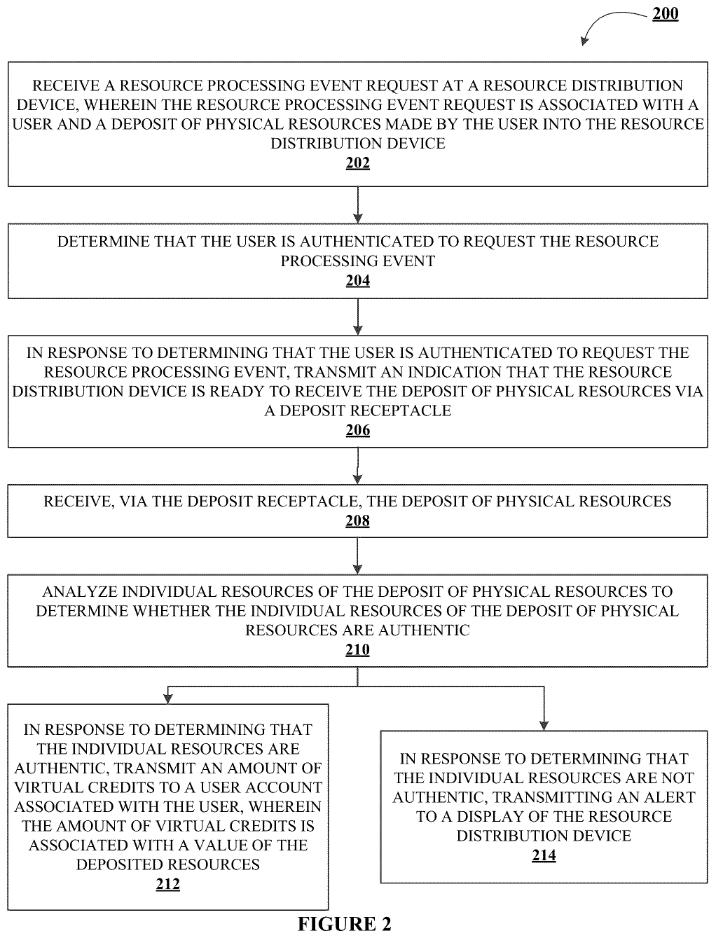

FIG. 2 illustrates a process flow 200 for analyzing individual resources of the deposit of physical resources to determine whether the individual resources of the deposit of physical resources are authentic, in accordance with an embodiment of the present disclosure. The method may be carried out by various components of the distributed computing environment 100 discussed herein (e.g., the system 130, one or more end-point device(s) 140, and the like). An example system may include at least one non-transitory storage device and at least one processing device coupled to the at least one non-transitory storage device. In such an embodiment, the at least one processing device is configured to carry out the method discussed herein. Unless otherwise noted, each of the features of FIGS. 2-5 may be carried out by various components of the distributed computing environment 100.

In some embodiments, an interconnected resource distribution system (e.g., similar to one or more of the systems described herein with respect to FIGS. 1A-1C) may perform one or more of the steps of the process flow 200. For example, an interconnected resource distribution system (e.g., the system 130 described herein with respect to FIGS. 1A-1C) may perform the steps of process flow 200.

As shown in block 202, the process flow 200 may include the step of receiving a resource processing event request at a resource distribution device, wherein the resource processing event request is associated with a user and a deposit of physical resource made by the user into the resource distribution device.

In some embodiments, the interconnected resource distribution system 130 may receive the resource processing event request from the network (e.g., network 110 of FIGS. 1A-1C). In some embodiments, the interconnected resource distribution system 130 may receive the resource processing event request through a communication device (e.g., a networking device coupled with the low-speed expansion port 114 of FIGS. 1A-1C). In some embodiments, the network (e.g., network 110 of FIGS. 1A-1C) may receive the resource processing event request from an end-point device (e.g., end-point device 140 of FIGS. 1A-1C). In some embodiments, the interconnected resource distribution system 130 may store the resource processing event request in a storage device (e.g., memory 104 or storage device 106 in FIGS. 1A-1C).

In some embodiments, a deposit of physical resources may include a deposit of any type of resources (e.g., cash, coins, and/or the like). In some embodiments, the deposit of physical resources may be made by the user. In some embodiments, the deposit of physical resources may be made at the command of the user.

In some embodiments, a resource processing event request may include a request sent from a device requesting the interconnected resource distribution system 130 to process a transaction. In some embodiments, the resource processing event request may include any type of transaction associated with a user account. In some embodiments, the resource processing event request may include a user requesting a specified amount of resources to be processed at the resource distribution device by the interconnected resource distribution system. In some embodiments, the resource processing event request may include any type of transaction involving physical resources. In some embodiments, the resource processing event request may include depositing physical resources into the resource distribution device. In some embodiments, the resource processing event request may include withdrawing physical resources from the resource distribution device.

In some embodiments, the resource processing event request may be sent from any type of device (e.g., an end-point device, a user device, a merchant device, a financial terminal, an ATM, a kiosk, a financial terminal, and/or the like).

In some embodiments, a resource distribution device may include any device that may receive a resource processing event request. In some embodiments, the resource distribution device may be associated with the entity (e.g., financial institution) associated with the user account. In some embodiments, the resource distribution device may be associated with an entity other than the one associated with the user account. In some embodiments, the resource distribution device may be a self-checkout system (e.g., self-checkout terminal, assisted checkout, self-service checkout, self-checkout kiosk, and/or the like) that allow a user to complete the user's own transaction without the need for conventional checkout personnel.

As shown in block 204, the process flow 200 may include the step of determining that the user is authenticated to request the resource processing event. In some embodiments, the interconnected resource distribution system 130 may determine that the user is authenticated to request the resource processing event in a processor (e.g., processor 102 in FIGS. 1A-1C).

This step of determining that the user is authenticated may, in some embodiments, comprise transmitting a request for authentication credentials associated with the user account to a user device in response to receiving the resource processing request. In some embodiments, the request for authentication credentials may require the user to provide authentication credentials to the interconnected resource distribution system 130. In some embodiments, the interconnected resource distribution system 130 may send the request for the authentication credentials from a processor (e.g., processor 102 in FIGS. 1A-1C). In some embodiments, the interconnected resource distribution system 130 may store the request for authentication credentials in a storage device (e.g., memory 104 or storage device 106 in FIGS. 1A-1C). In some embodiments, the interconnected resource distribution system 130 may request authentication credentials through a network (e.g., network 110 in FIGS. 1A-1C). In some embodiments, the interconnected resource distribution system 130 may request authentication credentials through an end-point device (e.g., end-point device(s) 140 in FIGS. 1A-1C).

The system may utilize know-your-customer or other user authentication information that the user provides to a peer-to-peer resource sharing network associated with the managing entity (and/or other entities associated with the resource distribution device) as the means for authenticating the user for the resource processing events described herein. Such peer-to-peer resource sharing networks also may have financial account information for the user, as well as for merchants or other entities associated with the resource distribution devices themselves. As such, the peer-to-peer resource sharing networks can be used to further authenticate the account(s) of the user associated with the resource processing event to confirm whether such accounts are authorized for the resource processing event, and to assist the system in tracking amounts and values associated with the accounts of the user and/or the merchants or entities associated with the resource distribution devices.

The interconnected resource distribution system 130 may then receive, from the user device, authentication credentials. Once the interconnected resource distribution system 130 receives the authentication credentials of the user, the interconnected resource distribution system 130 can then determine that the received authentication credentials match known authentication credentials associated with the user.

In response to determining that the received authentication credentials match the known authentication credentials, the interconnected resource distribution system 130 may then initiate the execution of the resource processing event. In some embodiments, the interconnected resource distribution system 130 may initiate execution of the resource processing event in a processor (e.g., processor 102 in FIGS. 1A-1C). In some embodiments, the interconnected resource distribution system 130 may initiate execution of the resource processing event through a network (e.g., network 110 in FIGS. 1A-1C). In some embodiments, the interconnected resource distribution system 130 may initiate execution of the resource processing event through an end-point device (e.g., end-point device(s) 140 in FIGS. 1A-1C).

The interconnected resource distribution system 130 may also transmit a confirmation of the authentication to the user device in response to determining that the received authentication credentials match the known authentication credentials. In some embodiments, the interconnected resource distribution system 130 may transmit the confirmation from a processor (e.g., processor 102 in FIGS. 1A-1C). In some embodiments, the interconnected resource distribution system 130 may transmit the confirmation to a network (e.g., network 110 in FIGS. 1A-1C). In some embodiments, the interconnected resource distribution system 130 may transmit the confirmation to an end-point device (e.g., end-point device(s) 140 in FIGS. 1A-1C).

As shown in block 206, the process flow 200 may include the step of, in response to determining that the user is authenticated to request the resource processing event, transmit an indication that the resource distribution device is ready to receive the deposit of physical resources via a deposit receptacle. In some embodiments, the interconnected resource distribution system may transmit the indication through a communication device (e.g., a networking device coupled with the low-speed expansion port 114 in FIGS. 1A-1C). In some embodiments, the interconnected resource distribution system may transmit the indication to a network (e.g., network 110 in FIGS. 1A-1C). In some embodiments, the interconnected resource distribution system 130 may transmit the indication from a processor (e.g., processor 102 in FIGS. 1A-1C). In some embodiments, the interconnected resource distribution system 130 may transmit the indication from the resource distribution device (e.g., through an alarm, a light, a prompt, and/or the like).

As used herein, “transmitting” may encompass a variety of definitions. For example, transmitting may include communicating, conveying, relaying, disseminating, spreading, and/or the like. For instance, and by way of non-limiting example, the interconnected resource distribution system 130 may communicate or convey an indication that the resource distribution device is ready to receive the deposit of physical resources via a deposit receptacle.

The term “indication” may include signal, notification, reminder, prompt, warning, and/or the like. For instance, and by way of non-limiting example, the interconnected resource distribution system 130 may transmit a signal or notification that the resource device is ready to receive the deposit of physical resource via a deposit receptacle. In some embodiments, the interconnected resource distribution system 130 may transmit the indication to any device. In some embodiments, the interconnected resource distribution system 130 may transmit the indication to the resource distribution device. In some embodiments, the interconnected resource distribution system 130 may transmit the indication to the user device.

In some embodiments, the transmission of the indication may not require any further interaction from the user for the interconnected resource distribution system to receive the deposit of physical resources. In some embodiments, the interconnected resource distribution system 130 may require user interaction before the physical resources are deposited. For instance, and by way of non-limiting example, the interconnected resource distribution system 130 may require the user to interact with the indication (e.g., prompt) on a device (e.g., the resource distribution device, the user device, and/or the like) before receiving the deposit of physical resources.

The term “ready to receive” may include that the interconnected resource distribution system is at the appropriate stage in the process to proceed with the next step. For example, the interconnected resource distribution system may be prepared, set, and/or the like to receive the deposit of physical resources.

The term “deposit receptacle” may include any component capable of receiving physical resources. In some embodiments, the deposit receptacle may have the capability to receive cash, checks, cashier's checks, money orders, and/or the like. In some embodiments, the interconnected resource distribution system 130 may be configured to perform a variety of tasks once the deposit is received. For instance, and by way of non-limiting example, the interconnected resource distribution system 130 may be configured to determine the amount of resources deposited (e.g., count) and determine the total resources deposited.

In some embodiments, the deposit receptacle may be an opening (e.g., slot) where the user may insert physical resources (e.g., cash) into the resource distribution device. In some embodiments, the deposit receptacle may include a scanning device that may capture information relating to any type of payment instrument (e.g., check, debit card, credit card, cashier's check, money order, and/or the like). In some embodiments, the deposit receptacle may be physically attached to the resource distribution device. In some embodiments, the deposit receptacle may be a stand-alone device, physically separated from the resource distribution device. In some embodiments, the deposit receptacle may be communicatively coupled to the resource distribution device. In some embodiments, the deposit receptacle may be communicatively coupled to the resource distribution device through any coupling (e.g., communication) means. In some embodiments, the deposit receptacle may be communicatively coupled to the resource distribution device through a network (e.g., network 110 in FIGS. 1A-1C). In some embodiments, the deposit receptacle may be communicatively coupled to the resource distribution device through a physical means (e.g., an information cable, an ethernet cable, a USB cable, and/or the like).

As shown in block 208, the process flow 200 may include the step of receiving, via the deposit receptacle, the deposit of physical resources. In some embodiments, the interconnected resource distribution system 130 may transmit a receipt indication. In some embodiments, the receipt indication may include that the resource distribution device has received the deposit of physical resources (e.g., via the deposit receptacle).

In some embodiments, the interconnected resource distribution system 130 may transmit the receipt indication through a communication device (e.g., a networking device coupled with the low-speed expansion port 114 in FIGS. 1A-1C). In some embodiments, the interconnected resource distribution system 130 may transmit the receipt indication to a network (e.g., network 110 in FIGS. 1A-1C). In some embodiments, the interconnected resource distribution system 130 may transmit the receipt indication to an end-point device (e.g., end-point device(s) 140 in FIGS. 1A-1C). In some embodiments, the receipt indication may be transmitted to the resource distribution device. In some embodiments, the receipt indication may be transmitted to the user device. In some embodiments, the receipt indication may configure a graphical user interface of an entity device (e.g., the user device, the resource distribution device, end-point device(s) 140 in FIGS. 1A-1C, and/or the like).

As shown in block 210, the process flow 200 may include the step of analyzing individual resources of the deposit of physical resources to determine whether the individual resources of the deposit of physical resources are authentic. In some embodiments, the interconnected resource distribution system 130 may analyze the received resources in a processor (e.g., processor 102 in FIGS. 1A-1C). The term “analyzing” may include determining, examining, scanning, inspecting, and/or the like. For instance, and by way of non-limiting example, the interconnected resource distribution system 130 may examine or scan the received resources. In some embodiments, the analysis of the received resources may happen instantaneously as soon as the resources are received.

In some embodiments, the interconnected resource distribution system 130 may determine whether the received resources are authentic in response to regulations (e.g., Federal Deposit Insurance Corporation (FDIC) standards, federal regulations, state regulations, and/or the like). In some embodiments, the interconnected resource distribution system 130 may determine whether the received resources are authentic in response to the physical resources security marks (e.g., watermark, color-shifting ink, security thread, 3-D security ribbon, serial numbers, and/or the like).

As shown in block 212, the process flow 200 may include the step of, in response to determining that the individual resources are authentic, transmit an amount of virtual credits to a user account associated with the user, wherein the amount of virtual credits is associated with a value of the deposited resources.

In some embodiments, the interconnected resource distribution system 130 may perform the step of transmitting virtual credits in a processor (e.g., processor 102 in FIGS. 1A-1C). In some embodiments, the interconnected resource distribution system 130 may store the virtual credits in a storage device (e.g., memory 104, storage device 106, and/or the like of FIGS. 1A-1C). In some embodiments, the interconnected resource distribution system 130 may transmit the virtual credits through a communication device (e.g., a networking device coupled with the low-speed expansion port 114 of FIGS. 1A-1C). In some embodiments, the interconnected resource distribution system 130 may transmit the virtual credits to a network (e.g., network 110 of FIGS. 1A-1C). In some embodiments, the interconnected resource distribution system 130 may transmit the virtual credits to an end-point device (e.g., end-point device(s) 140 of FIGS. 1A-1C).

In some embodiments, the virtual credits may include any electronic or digital resources, electronic or digital currencies, electronic or digital funds, and/or the like. In some embodiments, virtual credits may include any money balance recorded electronically, allowing the transfer of the resource (e.g., value) on a network (e.g., network 110 of FIGS. 1A-1C), including the Internet. In some embodiments, the virtual credits may include any monetary value stored in any device or instrument (e.g., payment instrument or the like), and may include resources stored on any device (e.g., a user device, a server, and/or the like).

In some embodiments, transmitting the virtual credits may include an electronic funds transfer (EFT). In some embodiments, an EFT is a transfer of resources from one account to another. In some embodiments, the virtual credits may be transmitted (e.g., transferred) within a single entity (e.g., the entity associated with the user account). In some embodiments, the virtual credits may be transmitted (e.g., transferred) across one or more entities, including entities that are not associated with the user account.

In some embodiments, the virtual credits may be transmitted (e.g., transferred) to a user account through a payment instrument (e.g., debit card, bank card, credit card, and/or the like). For instance, and by way of non-limiting example, the interconnected resource distribution system 130 may transmit the virtual credits to the resource distribution device, and the user may receive the virtual credits by inserting a payment instrument into the resource distribution device. In this way, the resource distribution device may transfer virtual credits associated with the deposited physical resources to an account associated with the user by way of a payment instrument.

As shown in block 214, the process flow 200 may include the step of, in response to determining that the individual resources are not authentic, transmitting an alert to a display of the resource distribution device. In some embodiments, the interconnected resource distribution system 130 may transmit the alert in a processor (e.g., processor 102 of FIGS. 1A-1C). In some embodiments, the interconnected resource distribution system 130 may store the alert in a storage device (e.g., memory 104 or storage device 106 in FIGS. 1A-1C). In some embodiments, the interconnected resource distribution system 130 may transmit the alert with a communication device (e.g., a networking device coupled with the low-speed expansion port 114 in FIGS. 1A-1C). In some embodiments, the interconnected resource distribution system 130 may transmit the alert to an end-point device (e.g., end-point device(s) 140 in FIGS. 1A-1C).

In some embodiments, the alert may configure a graphical user interface of an entity device. In some embodiments, the entity device may include a device associated with at least one of the user, a manager of the resource distribution device, a manager of the entity associated with the user account (e.g., financial institution), or an agency (e.g., the local police, state investigation agencies, the federal investigation agencies, and/or the like). In some embodiments, the alert may be transmitted to any combination of user devices, manager devices, or agency devices.

In some embodiments, the alert may be transmitted from the interconnected resource distribution system 130 to a user device associated with the real user of the user account. In this manner, the interconnected resource distribution system 130 may indicate to the real user of the user account that there was an attempt to deposit inauthentic resources and may request the user to complete a variety of tasks. In some embodiments, the variety of tasks may include one of contacting the manager of the resource distribution device, contacting the manager of the financial institution associated with the user account, and/or the like. In some embodiments, the interconnected resource distribution system 130 itself may automatically transmit an indication and/or the alert to the manager of the resource distribution device or the manager of the financial institution associated with the user account indicating that the resource processing request has occurred, without the real user's interference and/or approval.

In some embodiments, the alert may include a deterrence action. In some embodiments, the deterrence action may be transmitted simultaneously with the alert. In some embodiments, the deterrence action may include forcing the resource distribution device to automatically reject the transaction of concern. In some embodiments, the deterrence action may include shutting down the resource distribution device for a specified amount of time (e.g., 30 minutes, one hour, two hours, 24 hours, and/or the like). In some embodiments, the deterrence action may include shutting down the resource distribution device until authorized personnel (e.g., a manager of the resource distribution device, a manager of the financial institution associated with the user account, and/or the like) reactivates the resource distribution device.

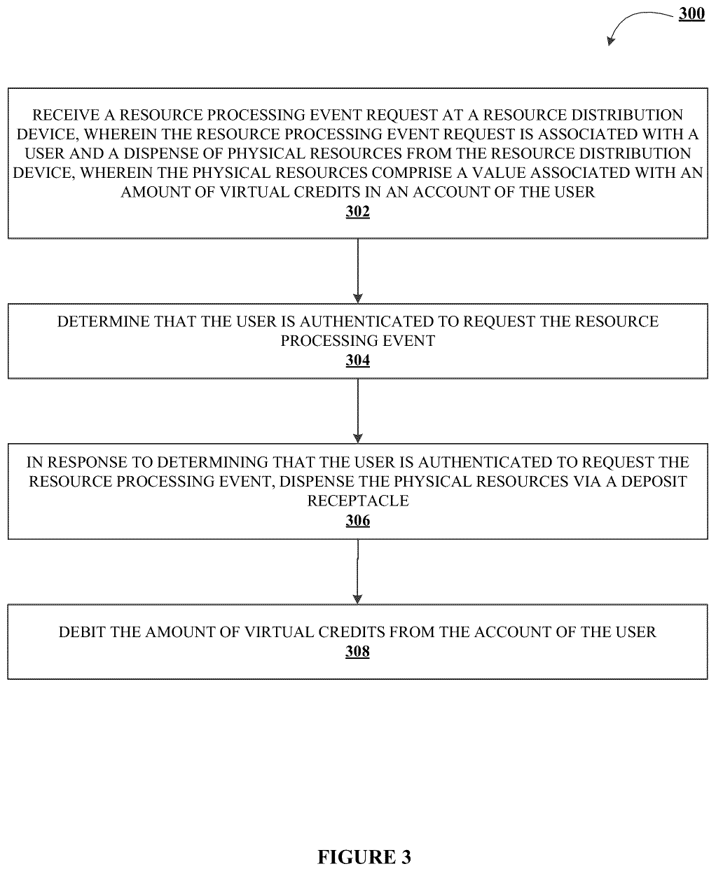

FIG. 3 illustrates a process flow 300 for debiting the amount of virtual credits from the account of the user, in accordance with an embodiment of the present disclosure. The method may be carried out by various components of the distributed computing environment 100 discussed herein (e.g., the system 130, one or more end-point device(s) 140, and the like). An example system may include at least one non-transitory storage device and at least one processing device coupled to the at least one non-transitory storage device. In such an embodiment, the at least one processing device is configured to carry out the method discussed herein.

In some embodiments, an interconnected resource distribution system (e.g., similar to one or more of the systems described herein with respect to FIGS. 1A-1C) may perform one or more of the steps of the process flow 300. For example, an interconnected resource distribution system (e.g., the system 130 described herein with respect to FIGS. 1A-1C) may perform the steps of process flow 300.

As shown in block 302, the process flow 300 may include the step of receiving a resource processing event request at a resource distribution device, wherein the resource processing event request is associated with a user and a dispense of physical resources from the resource distribution device, wherein the physical resources comprise a value associated with an amount of virtual credits in an account of the user.

In some embodiments, the user account does not necessarily need to be managed by the same entity that manages the resource distribution device. For instance, and by way of non-limiting example, the user account may comprise a user account associated with an entity different than the entity that manages the resource distribution device. In such embodiments, the different entities may be part of a collective organization, or may otherwise have an agreement and process in place to facilitate the transfer of resources between the entities.

As shown in block 304, the process flow 300 may include the step of determining that the user is authenticated to request the resource processing event. This step may comprise any of the embodiments described with respect to block 204 of FIG. 2, as described above.

As shown in block 306, the process flow 300 may include the step of, in response to determining that the user is authenticated to request the resource processing event, dispensing the physical resources via a deposit receptacle. In some embodiments, the interconnected resource distribution system 130 may cause the dispensing of the physical resources from a processor (e.g., processor 102 in FIGS. 1A-1C). In some embodiments, the system may be configured to dispense physical resources at the resource distribution device. The term “dispense” may include distribute, disburse, eject, display, and/or the like. For instance, and by way of non-limiting example, the interconnected resource distribution system 130 may be configured to distribute or disburse physical resources at the resource distribution device.

In some embodiments, the authentication may further comprise, in response to the user being authenticated, transmitting a confirmation of the authentication. In some embodiments, the interconnected resource distribution system 130 may cause transmission of the confirmation from a processor (e.g., processor 102 in FIGS. 1A-1C). In some embodiments, the interconnected resource distribution system 130 may transmit the confirmation to a network (e.g., network 110 in FIGS. 1A-1C). In some embodiments, the interconnected resource distribution system 130 may transmit the confirmation to an end-point device (e.g., end-point device(s) 140 in FIGS. 1A-1C). In some embodiments, the confirmation may configure a graphical user interface of an entity device (e.g., the user device, the resource distribution device, end-point device(s) 140 in FIGS. 1A-1C, and/or the like).

As shown in block 308, the process flow 300 may include the step of debiting the amount of virtual credits from the account of the user. The term “debit” may include subtract, deduct, remove, and/or the like. For instance, and by way of non-limiting example, the interconnected resource distribution system 130 may subtract or deduct the amount of virtual credits from the account of the user.

In some embodiments, a debit confirmation may be transmitted once the interconnected resource distribution system 130 has debited the account of the user. In some embodiments, the debit confirmation may include debit confirmation data. In some embodiments, the debit confirmation data may include the date and time of the resource processing event, the amount of resources requested to be processed, the location of the resource processing event, information relating to the resource distribution device (e.g., the entity associated with the resource distribution device), and/or the like.

In some embodiments, the interconnected resource distribution system 130 may transmit the debit confirmation from a processor (e.g., processor 102 in FIGS. 1A-1C). In some embodiments, the interconnected resource distribution system 130 may transmit the debit confirmation to a network (e.g., network 110 in FIGS. 1A-1C). In some embodiments, the interconnected resource distribution system 130 may transmit the debit confirmation to an end-point device (e.g., end-point device(s) 140 in FIGS. 1A-1C).

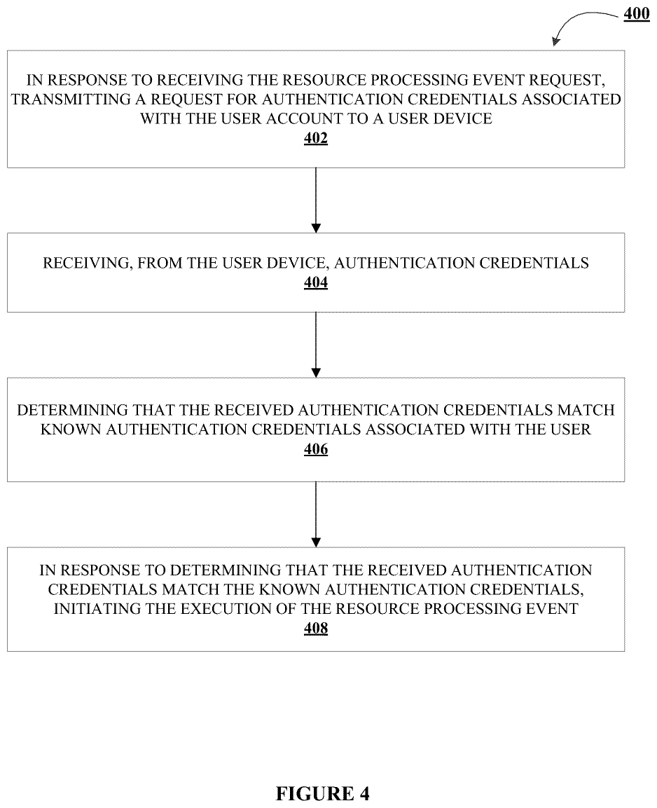

FIG. 4 illustrates a process flow 400 for implementing an interconnected distributed network of resource distribution devices, including initiating the execution of the resource processing event, in accordance with an embodiment of the disclosure. The method may be carried out by various components of the distributed computing environment 100 discussed herein (e.g., the system 130, one or more end-point device(s) 140, and the like). An example system may include at least one non-transitory storage device and at least one processing device coupled to the at least one non-transitory storage device. In such an embodiment, the at least one processing device is configured to carry out the method discussed herein.

In some embodiments, an interconnected resource distribution system (e.g., similar to one or more of the systems described herein with respect to FIGS. 1A-1C) may perform one or more of the steps of process flow 400. For example, an interconnected resource distribution system (e.g., the system 130 described herein with respect to FIGS. 1A-1C) may perform the steps of process flow 400.

As shown in block 402, the process flow 400 may include the step of, in response to receiving the resource processing event request, transmitting a request for authentication credentials associated with the user account to a user device. In some embodiments, the interconnected resource distribution system 130 may transmit the request for authentication credentials in a processor (e.g., processor 102 of FIGS. 1A-1C). In some embodiments, the interconnected resource distribution system 130 may store the request for authentication credentials in a storage device (e.g., memory 104 or storage device 106 in FIGS. 1A-1C). In some embodiments, the interconnected resource distribution system 130 may transmit the request for authentication credentials with a communication device (e.g., a networking device coupled with the low-speed expansion port 114 in FIGS. 1A-1C). In some embodiments, the interconnected resource distribution system 130 may transmit the request for authentication credentials to a network (e.g., network 110 in FIGS. 1A-1C). In some embodiments, the interconnected resource distribution system 130 may transmit the request for authentication credentials to an end-point device (e.g., end-point device(s) 140 in FIGS. 1A-1C).

In some embodiments, the request for authentication credentials associated with the user account to the user device may include a request for the user to enter the authentication credentials into a device (e.g., user device, resource distribution device, third-party device, and/or the like). In some embodiments, the request for authentication credentials may be transmitted through a variety of different communication protocols (e.g., Hypertext Transfer Protocol (HTTP), Hypertext Transfer Protocol Secure (HTTPS), Simple Mail Transfer Protocol (SMTP), File Transfer Protocol (FTP), and/or the like).

As shown in block 404, the process flow 400 may include the step of receiving, from the user device, authentication credentials. In some embodiments, the interconnected resource distribution system 130 may receive the authentication credentials from a network (e.g., network 110 in FIGS. 1A-1C). In some embodiments, the interconnected resource distribution system 130 may receive the authentication credentials from an end-point device (e.g., end-point device(s) 140 in FIGS. 1A-1C). In some embodiments, the interconnected resource distribution system 130 may receive the authentication credentials through a communication device (e.g., a networking device coupled with the low-speed expansion port 114 in FIGS. 1A-1C).

As shown in block 406, the process flow 400 may include the step of determining that the received authentication credentials match known authentication credentials associated with the user. In some embodiments, the interconnected resource distribution system 130 may determine that the received authentication credentials match known authentication credentials in a processor (e.g., processor 102 in FIGS. 1A-1C). In some embodiments, the interconnected resource distribution system 130 may store the received authentication credentials in a storage device (e.g., memory 104 or storage device 106 in FIGS. 1A-1C). In some embodiments, the interconnected resource distribution system 130 may store the known authentication credentials in a storage device (e.g., memory 104 or storage device 106 in FIGS. 1A-1C).

In some embodiments, the known authentication credentials may be authentication credentials the user has previously provided to the interconnected resource distribution system 130. In some embodiments, the known authentication credentials may be provided by the entity associated with the user account to another entity associated with the resource distribution device. For instance, and by way of non-limiting example, if the user account is associated with a first entity, and the resource distribution device is associated with a second entity, the first entity may provide the second entity with the known authentication credentials of the user in order for the interconnected resource distribution system 130 to match the received authentication credentials with the known authentication credentials.

As shown in block 408, the process flow 400 may include the step of, in response to determining that the received authentication credentials match the known authentication credentials, initiating the execution of the resource processing event. In some embodiments, the interconnected resource distribution system 130 may determine that the received authentication credentials match the known authentication credentials in a processor (e.g., processor 102 in FIGS. 1A-1C). In some embodiments, the interconnected resource distribution system 130 may cause an execution of the resource processing request in a processor (e.g., processor 102 in FIGS. 1A-1C).

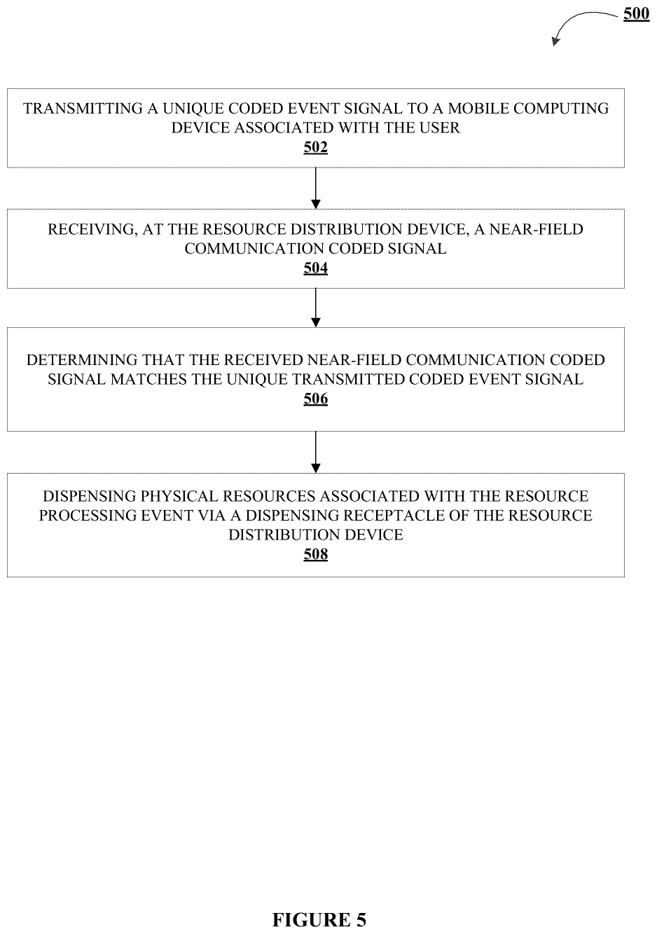

FIG. 5 illustrates a process flow 500 for implementing an interconnected distributed network of resource distribution devices, including dispensing physical resources associated with the resource processing event via a dispensing receptacle of the resource distribution device, in accordance with an embodiment of the present disclosure. In some embodiments, receiving the resource processing event request comprises receiving a request to execute the resource processing event at a future point in time. This process flow 500 can enable a user to interact with the system, through a computing device system of the user, at a prior point in time to initiate the request for the resource processing event, to authenticate the user, to select the account(s) of the user that the user would like to be associated with the resource processing event, and the like. By communicating between the user device and the resource distribution device (or the system in general) prior to the user's physical interaction with the resource distribution device, this process flow 500 provides for user time efficiencies, computer processing efficiencies, improved authentication of users and/or resources, and improved resource distribution security over conventional resource distribution devices and networks.

The method may be carried out by various components of the distributed computing environment 100 discussed herein (e.g., the system 130, one or more end-point device(s) 140, and the like). An example system may include at least one non-transitory storage device and at least one processing device coupled to the at least one non-transitory storage device. In such an embodiment, the at least one processing device is configured to carry out the method discussed herein.

In some embodiments, an interconnected resource distribution system (e.g., similar to one or more of the systems described herein with respect to FIGS. 1A-1C) may perform one or more of the steps of process flow 500. For example, an interconnected resource distribution system (e.g., the system 130 described herein with respect to FIGS. 1A-1C) may perform the steps of process flow 500.

As shown in block 502, the process flow 500 may include the step of transmitting a unique coded event signal to a mobile computing device associated with the user. In some embodiments, the interconnected resource distribution system 130 may transmit the unique coded event signal from a processor (e.g., processor 102 in FIGS. 1A-1C). In some embodiments, the interconnected resource distribution system 130 may transmit the unique coded event signal to a network (e.g., network 110 in FIGS. 1A-1C). In some embodiments, the interconnected resource distribution system 130 may transmit the unique coded event signal to an end-point device (e.g., end-point device(s) 140 in FIGS. 1A-1C). In some embodiments, the interconnected resource distribution system 130 may store the unique coded event signal in a storage device (e.g., memory 104 or storage device 106 in FIGS. 1A-1C).

In some embodiments, the unique coded event signal may include information relating to a resource processing event request. In some embodiments, the resource processing event request may comprise a request to execute the resource processing event at a future point in time. In some embodiments, the future point in time can be any future point in time, or any range of time in the future. In some embodiments, the user may select a future point in time to execute the resource processing event. In some embodiments, the user may select a range of time in the future to execute the resource processing event. In some embodiments, the user may select the future point in time from a user device. In some embodiments, the user may select the future point in time from an end-point device (e.g., end-point device(s) 140 in FIGS. 1A-1C).

In some embodiments, the unique coded event signal may be protected by one or more encryption methods (e.g., symmetric encryption, asymmetric encryption, end-to-end encryption, and/or the like).

As shown in block 504, the process flow 500 may include the step of receiving, at the resource distribution device, a near-field communication coded signal. In some embodiments, the near-field communication coded signal may include communication protocols that enable communication between two or more electronic devices over a distance. In some embodiments, the near-field communication coded signal may be protected by one or more encryption methods (e.g., symmetric encryption, asymmetric encryption, end-to-end encryption, and/or the like).

As shown in block 506, the process flow 500 may include the step of determining that the received near-field communication coded signal matches the unique transmitted coded event signal. In some embodiments, the interconnected resource distribution system 130 may determine that the received near-field communication coded signal matches the unique coded event signal in a processor (e.g., processor 102 in FIGS. 1A-1C). In some embodiments, the interconnected resource distribution system 130 may store the determination that the received near-field communication coded signal matches the unique coded event signal in a storage device (e.g., memory 104 or storage device 106 in FIGS. 1A-1C).

In some embodiments, “match” may refer to when the received near-field communication coded signal and the unique coded event signal are the same, equivalent, corresponding, and/or the like.

As shown in block 508, the process flow 500 may include the step of dispensing physical resources associated with the resource processing event via a dispensing receptacle of the resource distribution device. In some embodiments, the dispensing receptacle may be an opening (e.g., slot) where the interconnected resource distribution system 130 dispenses physical resources. In some embodiments, the dispensing receptacle may be physically attached to the resource distribution device. In some embodiments, the dispensing receptacle may be a stand-alone device, physically separated from the resource distribution device. In some embodiments, the dispensing receptacle may be communicatively coupled to the resource distribution device. In some embodiments, the dispensing receptacle may be communicatively coupled to the resource distribution device through any coupling (e.g., communication) means. In some embodiments, the dispensing receptacle may be communicatively coupled to the resource distribution device through a network (e.g., network 110 in FIGS. 1A-1C). In some embodiments, the dispensing receptacle may be communicatively coupled to the resource distribution device through a physical means (e.g., an information cable, an ethernet cable, a USB cable, and/or the like).

In some embodiments, the resource processing event request comprises receiving a request to execute the resource processing event at a specified resource distribution device. In some embodiments, initiating the execution of the resource processing event comprises transmitting a unique coded device signal to a mobile computing device associated with the user; receiving, at the specified resource distribution device, a near-field communication coded signal; determining that the received near-field communication coded signal matches the transmitted unique coded device signal; and dispensing physical resources associated with the resource processing event via a dispensing receptacle of the resource distribution device.

In some embodiments, the specified resource distribution device may be selected by the user. In some embodiments, the specified resource distribution device may be selected by the user from an end-point device (e.g., end-point device(s) 140 in FIGS. 1A-1C). In some embodiments, the specified resource distribution device may be selected by the user device associated with the user. In some embodiments, the unique coded device signal may be protected by encryption methods (e.g., symmetric encryption, asymmetric encryption, end-to-end encryption, and/or the like). In some embodiments, the near-field communication coded signal may be protected by one or more encryption methods (e.g., symmetric encryption, asymmetric encryption, end-to-end encryption, and/or the like). In some embodiments, the dispensing receptacle may comprise any of the embodiments described with respect to block 508 of FIG. 5, as described above.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for implementing an interconnected distributed network of resource distribution devices, the system comprising:
at least one non-transitory storage device; and
at least one processing device coupled to the at least one non-transitory storage device, wherein the at least one processing device is configured to:
receive a resource processing event request at a resource distribution device, wherein the resource processing event request is associated with a user;
determine that the user is authenticated to request the resource processing event; and
in response to determining that the user is authenticated to request the resource processing event, initiate execution of the resource processing event.

2. The system of claim 1, wherein the resource processing event comprises a deposit of physical resources made by the user into the resource distribution device, and wherein the at least one processing device is further configured to:
transmit an indication that the resource distribution device is ready to receive the deposit of physical resources via a deposit receptacle; and
receive, via the deposit receptacle, the deposit of physical resources.

3. The system of claim 2, wherein the at least one processing device is further configured to verify the deposit of physical resources, wherein verifying the deposit of physical resources comprises:
analyzing individual resources of the deposit of physical resources to determine whether the individual resources of the deposit of physical resources are authentic; and
in response to determining that the individual resources are authentic, transmitting an amount of virtual credits to a user account associated with the user, wherein the amount of virtual credits is associated with a value of the deposited resources; or
in response to determining that the individual resources are not authentic, transmitting an alert to a display of the resource distribution device.

4. The system of claim 1, wherein the resource processing event comprises a dispense of physical resources from the resource distribution device, wherein the physical resources comprise a value associated with an amount of virtual credits in an account of the user, and wherein the at least one processing device is further configured to:
dispense the physical resources via a deposit receptacle; and
debit the amount of virtual credits from the account of the user.

5. The system of claim 1, wherein determining that the user is authenticated further comprises:
in response to receiving the resource processing event request, transmitting a request for authentication credentials associated with the user account to a user device;
receiving, from the user device, authentication credentials;
determining that the received authentication credentials match known authentication credentials associated with the user; and
in response to determining that the received authentication credentials match the known authentication credentials, initiating the execution of the resource processing event.

6. The system of claim 5, wherein the at least one processing device is further configured to, in response to determining that the received authentication credentials match the known authentication credentials, transmit a confirmation of the authentication to the user device.

7. The system of claim 5, wherein the user account is associated with an entity different than an entity that manages the resource distribution device.

8. The system of claim 1, wherein receiving the resource processing event request comprises receiving a request to execute the resource processing event at a future point in time, and wherein initiating the execution of the resource processing event comprises:
transmitting a unique coded event signal to a mobile computing device associated with the user;
receiving, at the resource distribution device, a near-field communication coded signal;
determining that the received near-field communication coded signal matches the unique transmitted coded event signal; and
dispensing physical resources associated with the resource processing event via a dispensing receptacle of the resource distribution device.

9. A computer program product for implementing an interconnected distributed network of resource distribution devices, the computer program product comprising at least one non-transitory computer-readable medium having computer-readable code portions embodied therein, the computer-readable program code portions comprising:
an executable portion configured to receive a resource processing event request at a resource distribution device, wherein the resource processing event request is associated with a user;
an executable portion configured to determine that the user is authenticated to request the resource processing event; and
an executable portion configured to, in response to determining that the user is authenticated to request the resource processing event, initiate execution of the resource processing event.

10. The computer program product of claim 9, wherein the resource processing event comprises a deposit of physical resources made by the user into the resource distribution device, and wherein the computer program product further comprises an executable portion configured to:
transmit an indication that the resource distribution device is ready to receive the deposit of physical resources via a deposit receptacle; and
receive, via the deposit receptacle, the deposit of physical resources.

11. The computer program product of claim 10, wherein the computer program product further comprises an executable portion configured to verify the deposit of physical resources, wherein verifying the deposit of physical resources comprises:
analyzing individual resources of the deposit of physical resources to determine whether the individual resources of the deposit of physical resources are authentic; and
in response to determining that the individual resources are authentic, transmitting an amount of virtual credits to a user account associated with the user, wherein the amount of virtual credits is associated with a value of the deposited resources; or
in response to determining that the individual resources are not authentic, transmitting an alert to a display of the resource distribution device.

12. The computer program product of claim 9, wherein the resource processing event comprises a dispense of physical resources from the resource distribution device, wherein the physical resources comprise a value associated with an amount of virtual credits in an account of the user, and wherein the computer program product further comprises an executable portion configured to:
dispense the physical resources via a deposit receptacle; and
debit the amount of virtual credits from the account of the user.

13. The computer program product of claim 9, wherein determining that the user is authenticated further comprises:
in response to receiving the resource processing event request, transmitting a request for authentication credentials associated with the user account to a user device;
receiving, from the user device, authentication credentials;
determining that the received authentication credentials match known authentication credentials associated with the user; and
in response to determining that the received authentication credentials match the known authentication credentials, initiating the execution of the resource processing event.

14. The system of claim 13, wherein the computer program product further comprises an executable portion configured to, in response to determining that the received authentication credentials match the known authentication credentials, transmit a confirmation of the authentication to the user device.

15. The system of claim 13, wherein the user account is associated with an entity different than an entity that manages the resource distribution device.

16. The system of claim 9, wherein receiving the resource processing event request comprises receiving a request to execute the resource processing event at a future point in time, and wherein initiating the execution of the resource processing event comprises:
transmitting a unique coded event signal to a mobile computing device associated with the user;
receiving, at the resource distribution device, a near-field communication coded signal;
determining that the received near-field communication coded signal matches the unique transmitted coded event signal; and
dispensing physical resources associated with the resource processing event via a dispensing receptacle of the resource distribution device.

17. A computer-implemented method for implementing an interconnected distributed network of resource distribution devices, the computer-implemented method comprising:
receiving a resource processing event request at a resource distribution device, wherein the resource processing event request is associated with a user;
determining that the user is authenticated to request the resource processing event; and
in response to determining that the user is authenticated to request the resource processing event, initiating execution of the resource processing event.

18. The computer-implemented method of claim 17, wherein the resource processing event comprises a deposit of physical resources made by the user into the resource distribution device, and the computer-implemented method further comprising:
transmitting an indication that the resource distribution device is ready to receive the deposit of physical resources via a deposit receptacle; and
receiving, via the deposit receptacle, the deposit of physical resources.

19. The computer-implemented method of claim 18, further comprising verifying the deposit of physical resources, wherein verifying the deposit of physical resources comprises:
analyzing individual resources of the deposit of physical resources to determine whether the individual resources of the deposit of physical resources are authentic; and
in response to determining that the individual resources are authentic, transmitting an amount of virtual credits to a user account associated with the user, wherein the amount of virtual credits is associated with a value of the deposited resources; or
in response to determining that the individual resources are not authentic, transmitting an alert to a display of the resource distribution device.

20. The computer-implemented method of claim 17, wherein the resource processing event comprises a dispense of physical resources from the resource distribution device, wherein the physical resources comprise a value associated with an amount of virtual credits in an account of the user, and the computer-implemented method further comprising:
dispensing the physical resources via a deposit receptacle; and
debiting the amount of virtual credits from the account of the user.
